(19) United States
(12) Patent Application Publication
(10) Pub. No.: US 2016/0288172 A1
(43) Pub. Date: Oct. 6, 2016

(54) SORTER WITH DOUBLE RUNOUT LANES IN EACH BULLPEN AND METHOD FOR SORTING

(71) Applicant: Laitram, L.L.C., Harahan, LA (US)

(72) Inventor: Stephen G. Wargo, Laurel, MD (US)

(21) Appl. No.: 14/902,393

(22) PCT Filed: Jul. 15, 2014
(86) PCT No.: PCT/US2014/046596

§ 371 Date: Dec. 31, 2015

Related U.S. Application Data
(60) Provisional application No. 61/847,144, filed on Jul. 17, 2013.

(51) Int. Cl. B07C 3/08; B07C 7/00

(52) U.S. Cl. CPC B07C 3/08; B07C 7/00

(57) ABSTRACT

A sorter having bullpens with double runout lanes and a method for sorting to those bullpens. The sorter comprises a main conveyor conveying articles, such as mail pieces, parcels, or mail trays. Diverters disposed along the main conveyor selectively divert the articles to pairs of side-by-side runout lanes depending on the articles' destinations. Each pair of runout lanes is flanked on opposite sides across an aisle by a row of destinations, such as carts, baskets, bins, hampers, and pallets. Each article is diverted from the main conveyor onto the runout lane closer to its destination cart. An operator picks up the article and carries it across the aisle to the pre-assigned destination cart.

### BACKGROUND

The invention relates generally to sorting conveyors and more particularly to postal or parcel sorters and methods for sorting.

Many postal facilities use tray sorters to sort trays of mail by destination. In one typical set-up, as shown in FIG. 2, trays are conveyed on a main conveyor 10, which is flanked on one or both sides by a number of runout lanes 12. (Only one lane is shown in FIG. 2.) Carts L1-L7, R1-R7 are lined up in a row on each side of the runout lane 12. Each cart will be filled with trays of mail for a specific destination. In this example, there are 14 carts for 14 different destinations. The runout lane 12 may be, for example, a skate-wheel conveyor tilted downward from its entrance at the main conveyor 10 to its end stop 14. Mail destined for the carts L1-L7 or R1-R7 is diverted from the main conveyor 10 to the runout lane 12. Aisles A1, A2 are formed between the runout lane and each of the rows of flanking carts. The configuration is known as a bullpen 16. An operator O assigned to the bullpen lifts each tray from the runout lane, reads its destination, and carries it to the corresponding cart. If the operator is in the left aisle when he picks up a tray destined for a cart along the right aisle A2, he has to walk around the runout lane 12 to the other aisle to deposit the tray. Because the operator doesn't know a tray's destination without first inspecting the tray's label, he has to inspect all the labels if he wants to deposit all the trays along one row before walking around the conveyor to the other aisle to deposit the remaining trays. So an operator can minimize the distance he walks by inspecting more trays, remembering which go in which row, and depositing those in one row and then the other. But that requires more handling of the trays. And because the positions of the trays on the runout lane change as trays are removed and new trays are supplied, it is difficult for an operator to remember which trays he has already inspected.

### SUMMARY

A sorting system embodying features of the invention comprises a main conveyor for conveying articles in pairs of side-by-side left and right runout lanes. Each pair of runout lanes branches off from one side or the other of the main conveyor at branch points. A left set of destinations is disposed to the left of a corresponding one of the left turnout lanes. A left aisle is formed between the left set of destinations and the corresponding left runout lanes. A right set of destinations is disposed to the right of a corresponding one of the right turnout lanes. A right aisle is formed between the right set of destinations and the corresponding right runout lane. Diverters are disposed along the main conveyor at the branch points. A controller coupled to the diverters selectively activates the diverters to divert an article to the left or right runout lane corresponding to the destination for the article.

According to another aspect of the invention, a bullpen configuration for a sorter embodying features of the invention comprises first and second runout lanes receiving articles bound for different first and second destinations. The first and second runout lanes are adjacent and parallel to each other and have inner sides facing each other and opposite outer sides. The first destinations are arranged along the outer side of the first runout lane across a first aisle. The second destinations are arranged along the outer side of the second runout lane across the second aisle. The first aisle accommodates an operator transferring articles from the first runout lanes to the first destinations and the second aisle accommodates the operator transferring articles from the second runout lane to the second destinations.

In another aspect of the invention, a method for sorting articles comprises: (a) pre-assigning destinations to each of a plurality of articles; (b) conveying the articles along a main conveyor; and (c) selectively diverting the articles from the main conveyor to a plurality of bullpens configured with a pair of side-by-side runout lanes flanked on opposite sides across aisles by a row of destinations by diverting each article to the runout lane closer to its pre-assigned destination.

### BRIEF DESCRIPTION OF THE DRAWINGS

FIG. 1 is a top plan view of a bullpen portion of a conveyor embodying features of the invention; and

FIG. 2 is a top plan view of a bullpen of the prior art.

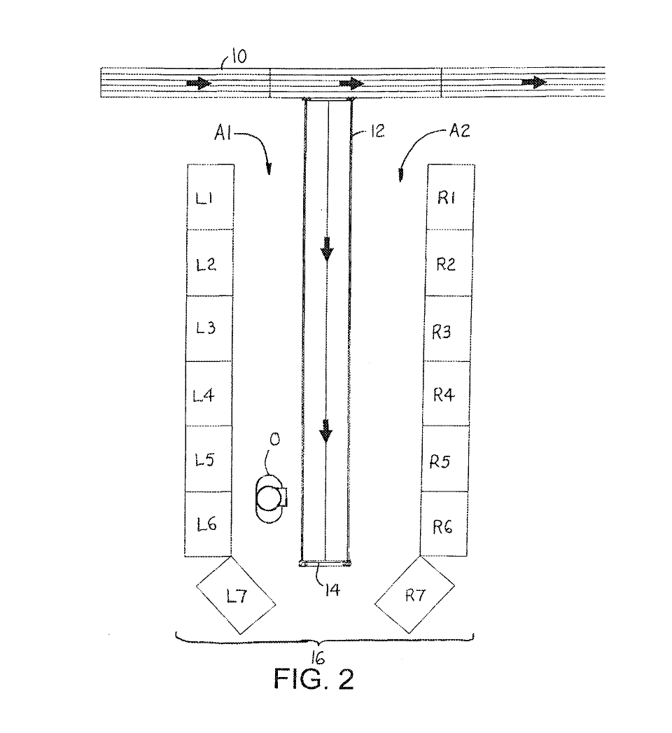

### DETAILED DESCRIPTION

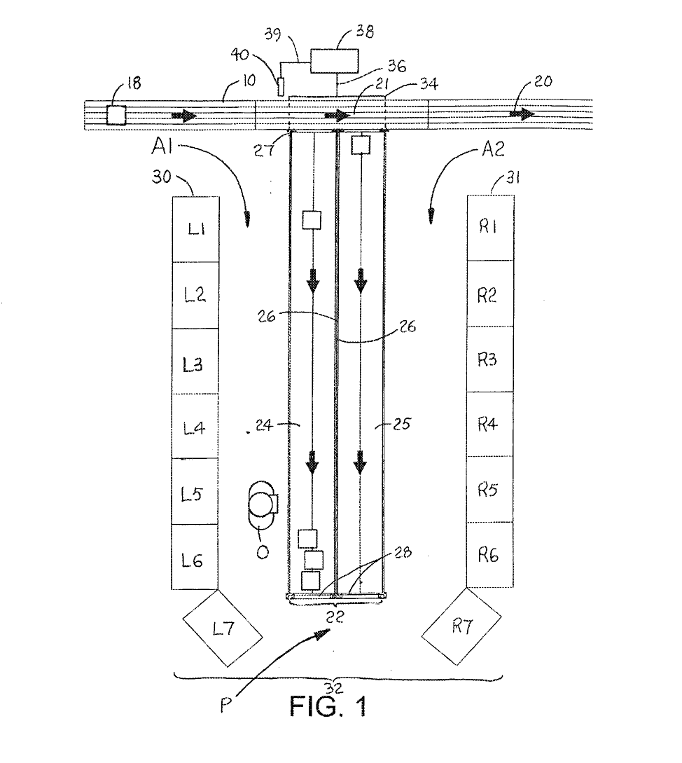

A conveyor system embodying features of the invention is shown in FIG. 1. A main conveyor 10 conveys articles 18, such as mail pieces, parcels, and containers or trays of mail pieces, in a conveying direction 20. The main conveyor 10 may be any suitable conveyor, such as a belt conveyor, a roller conveyor, or a slat conveyor. Branching off from either or both sides of the main conveyor at branch points 21 are pairs of side-by-side runout lanes 22: a left lane 24 and a right lane 25. The two lanes 24, 25 are shown parallel to each other with their facing inner sides 26 adjacent—in this example, abutting. The runout lanes 24, 25 can be realized, for example, with chutes, skate-wheel conveyors, or gravity roller conveyors elevated at their infeed ends 27 and terminated in lower end stops 28. Although FIG. 1 shows only one pair of runout lanes, the main conveyor 10 has many more pairs branching off from one or both sides.

Flanking the runout lanes 24, 25 are two sets 30, 31 of destination carts: a left set L1-L7 and a right set R1-R7. In this example, the carts in each set are arranged generally in a row that is parallel to its runout lane. Left and right aisles A1, A2 are formed between the runout lanes 24, 25 and their corresponding rows of destination carts 30, 31. Although carts are used in this example as destinations, other destinations, such as wire baskets, hampers, pallets, and collection bins or conveyors, are possible. The pair of runout lanes 24, 25, the flanking sets of destinations L1-L7, R1-R7, and the intervening aisles A1, A2 form the bullpen 32. The aisles, which are wide enough to accommodate a human operator O, are connected through a pathway P along the ends of the runout lanes 24, 25 distal from the main conveyor 10.

Diverters 34 at each branch point 21 selectively divert an article 18 to the left runout lane 24 or to the right runout lane 25 or pass the article along the main conveyor 10 to a downstream bullpen. The diverters may be swiveled-roller diverters, swinging gates, cross-belt diverters, pusher bars, or angled-roller-belt actuators, for example. The diverters 34 are activated by control signals 36 from a controller 38, such as a programmable controller or other computer. The controller has a priori knowledge of the pre-assigned destination of each article. When the controller 38 identifies the article from a sensor signal 39 sent by a sensor 40, such as a bar code reader positioned just upstream of the diverter 34, the controller determines if the article is destined for one of the left destinations L1-L7. If so, the controller sends an activation control signal 36 to the diverter 34 to divert the article onto the left runout lane 24. If the article is destined for one of the right destinations R1-R7, the controller 38 signals the diverter 34 to divert the article onto the right runout lane 25. If the article is destined for a downstream destination, the diverter is deactivated, and the article passes by the branch point to the downstream destination.

As the articles received on the runout lanes 24, 25 accumulate, the operator O can manually pick up and transfer all the articles on the left runout lane 24 into the corresponding left destinations L1-L7 while working in aisle A1. Then he can walk around the end of the pair of runout lanes in the bullpen 32 to the other aisle A2 to pick up and carry the articles on the right runout lane 25 to the corresponding destinations R1-R7. In this way, the operator can operate in one aisle at a time transferring articles from the runout lane to the closer row of destinations just across the aisle without having to walk back and forth from aisle to aisle so often and without having to handle each article more than once.

1. A sorting system comprising:
a main conveyor for conveying articles;
a plurality of pairs of side-by-side left and right runout lanes, each pair branching off from one or the other side of the main conveyor at branch points;
a left set of destinations disposed to the left of a corresponding one of the left runout lanes and forming a left aisle between the left set of destinations and the corresponding left runout lane;
a right set of destinations disposed to the right of a corresponding one of the right runout lanes and forming a right aisle between the right set of destinations and the corresponding right runout lane;
a plurality of diverters disposed along the main conveyor at the branch points;
a controller coupled to the diverters to selectively activate the diverters to divert an article to the left or right runout lane corresponding to the destination for the article.

2. A sorting system as in claim 1 further comprising a pathway connected between the left and right aisles at an end of the left and right runout lanes distal from the main conveyor.

3. A sorting system as in claim 1 wherein the right set of destinations forms a right row parallel to the right runout lane and the left set of destinations forms a left row parallel to the left runout lane.

4. A sorting system as in claim 1 wherein the right and left aisles are wide enough to accommodate a human operator.

5. A sorting system as in claim 1 further comprising at least one sensor disposed along the main conveyor sensing the articles and sending sensor signals to the controller for determining a pre-assigned destination for each of the articles.

6. A bullpen configuration for a sorter comprising:
a first runout lane receiving articles bound for a plurality of first destinations;
a second runout lane receiving articles bound for a plurality of different second destinations, wherein the second runout lane is adjacent and parallel to the first runout lane;
wherein the first and second runout lanes each have an inner side facing the inner side of the adjacent runout lane and an opposite outer side;
wherein the first destinations are arranged along the outer side of the first runout lane across a first aisle; and
wherein the second destinations are arranged along the outer side of the second runout lane across a second aisle;
wherein the first aisle accommodates an operator transferring articles from the first runout lanes to the first destinations and the second aisle accommodates the operator transferring articles from the second runout lane to the second destinations.

7. A bullpen configuration as in claim 6 further comprising a pathway connected between the first and second aisles along an end of the first and second runout lanes.

8. A bullpen configuration as in claim 6 wherein the first destinations form a row parallel to the first runout lane and the second destinations form a row parallel to the second runout lane.

9. A bullpen configuration as in claim 6 wherein the first and second aisles are wide enough to accommodate a human operator.

10. A method for sorting articles, comprising:
pre-assigning destinations to each of a plurality of articles;
conveying the articles along a main conveyor;
selectively diverting the articles from the main conveyor to a plurality of bullpens configured with a pair of side-by-side runout lanes flanked on opposite sides across aisles by a row of destinations by diverting each article to the runout lane closer to its pre-assigned destination.

11. The method of claim 10 further comprising manually transferring the articles from each runout lane to closer row of destinations by a human operator in the intervening aisle.
